(19) United States
(12) Patent Application Publication
(10) Pub. No.: US 2019/0295001 A1
(43) Pub. Date: Sep. 26, 2019

(54) COGNITIVE DATA CURATION IN A COMPUTING ENVIRONMENT

(71) Applicant: INTERNATIONAL BUSINESS MACHINES CORPORATION, Armonk, NY (US)

(72) Inventors: Francesco FUSCO, Maynooth (IE); Francesco VIGLIATURO, Dublin (IE)

(73) Assignee: INTERNATIONAL BUSINESS MACHINES CORPORATION, Armonk, NY (US)

(21) Appl. No.: 15/927,217

(22) Filed: Mar. 21, 2018

(51) Int. Cl. G06N 99/00; G06F 17/30; G06N 5/04

(52) U.S. Cl. CPC G06N 99/005; G06N 5/04; G06F 17/30864; G06F 17/30516

(57) ABSTRACT

Various embodiments are provided for cognitive data curation in an Internet of Things (IoT) computing environment by a processor. Each data flow and mapping of the data flows may be related to one or more concepts and relationships between the one or more concepts. One or more inconsistencies may be identified between those data flows used to answer a query for time-series data pertaining to the one or more concepts. The inconsistencies between those of the plurality of data flows may be corrected using inference and reasoning via a machine learning operation.

### BACKGROUND OF THE INVENTION

### Field of the Invention

The present invention relates in general to computing systems, and more particularly to, various embodiments for cognitive data curation in an Internet of Things (IoT) computing environment using a computing processor.

### Description of the Related Art

In today's society, consumers, businesspersons, educators, and others communicate over a wide variety of mediums in real time, across great distances, and many times without boundaries or borders. The advent of computers and networking technologies have made possible the increase in the quality of life while enhancing day-to-day activities and simplifying the sharing of information.

Computing systems can include an Internet of Things (IoT), which is the interconnection of computing devices scattered across the globe using the existing Internet infrastructure. That is, IoT is based on the idea that everyday objects, not just computers and computer networks, can be readable, recognizable, locatable, addressable, and controllable via an IoT communications network (e.g., an ad-hoc system or the Internet). In other words, the IoT can refer to uniquely identifiable devices and their virtual representations in an Internet-like structure. As great strides and advances in technologies come to fruition, the greater the need to make progress in these systems advantageous for efficiency and improvement.

### SUMMARY OF THE INVENTION

Various embodiments are provided for cognitive data curation in an Internet of Things (IoT) computing environment by a processor. Each data flow and mapping of the data flows may be related to one or more concepts and relationships between the one or more concepts of a semantic knowledge base. One or more inconsistencies may be identified between those data flows used to answer a query for time-series data pertaining to the one or more concepts. The inconsistencies between those of the plurality of data flows may be corrected using inference via a machine learning operation and reasoning on the semantic knowledge base.

In addition to the foregoing exemplary method embodiment, other exemplary system and computer product embodiments are provided and supply related advantages.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is an additional block diagram depicting an exemplary functional relationship between various aspects of the present invention;

FIG. 5 is a block/flow diagram depicting an exemplary method for cognitive data curation in an Internet of Things (IoT) computing environment in accordance with an embodiment of the present invention;

FIG. 6 is a flowchart diagram depicting an exemplary method for cognitive data curation in an IoT computing environment in accordance with an embodiment of the present invention; and

FIG. 7 is a flowchart diagram depicting an additional exemplary method for cognitive data curation in an IoT computing environment in accordance with an embodiment of the present invention.

### DETAILED DESCRIPTION OF THE DRAWINGS

Computing systems may include large scale computing called “cloud computing,” in which resources may interact and/or be accessed via a communications system, such as a computer network. Resources may be software-rendered simulations and/or emulations of computing devices, storage devices, applications, and/or other computer-related devices and/or services run on one or more computing devices, such as a server. For example, a plurality of servers may communicate and/or share information that may expand and/or contract across servers depending on an amount of processing power, storage space, and/or other computing resources needed to accomplish requested tasks. The word “cloud” alludes to the cloud-shaped appearance of a diagram of interconnectivity between computing devices, computer networks, and/or other computer related devices that interact in such an arrangement.

The Internet of Things (IoT) is an emerging concept of computing devices that may be embedded in objects, especially appliances, and connected through a network. An IoT network may include one or more IoT devices or “smart devices”, which are physical objects such as appliances with computing devices embedded therein. Examples of network-enabled appliances may include computers, smartphones, laptops, home appliances, audio systems, televisions, security cameras, security sensors, among countless other examples. Such IoT computing systems may be employed in energy systems (e.g., energy grids), water networks, traffic networks, smart buildings, and the like.

For example, increasing amounts of data coming from interconnected sensing devices has the potential to transform many industries toward extremely pervasive data-driven insights and decision making. In most domains, data is stored in complex information technology (“IT”) systems that 1) are not in consumable format (e.g., not aligned in time or space and require some non-trivial combinations to produce values of interest), 2) are imprecise (noise), 3) spread across multiple data storage silos, often in isolation with each other (inconsistency), and 4) are difficult to find and navigate.

Thus, data navigation, validation, cleaning and preparation decreases computing efficiency and is a time-consuming task, which can contribute a significant amount of effort required to setup data-driven decision support processes. Also, as data-driven cognitive systems designed for decision support lead to increased automation, these cognitive systems may be exposed to increased risk when data is inconsistent, or erroneous. IoT devices can also be vulnerable to faults, cyber-attacks, and changing environments.

Thus, a need exists for providing computing systems with cognitive data curations so as to reduce the efforts and costs of setting up and maintaining a data-driven decision support system or other data science operation. In one aspect, the present invention provides cognitive data curation in an IoT computing environment by a processor. Each data flow and mapping of the data flows may be related to one or more concepts and relationships between the one or more concepts. One or more inconsistencies may be identified between those data flows used to answer a query for time-series data pertaining to the one or more concepts. The inconsistencies between those of the plurality of data flows may be corrected using inference and reasoning via a machine learning operation.

In one aspect, a user query may be received for time-series data about a selected concept over a time range. Unique and consistent data may be returned for the requested concept and with anomaly flags. In order to provide the unique and consistent data, data flows associated with concepts related to the object of the query may be identified and resolved by leveraging ontology relations. Any inconsistencies and/or anomalies may be identified between the multiple data flows that are provided for answering the query by leveraging underlying inference models. Each of the underlying data flows (e.g., the multiple data flows that are provided for answering the query) and knowledge base may be corrected via a machine learning operation and reasoning.

In one aspect, where inconsistencies and anomaly flags cannot be uniquely identified and resolved, a request may be sent (e.g., to a user) for input through a cognitive dialog operation (e.g., interactive cognitive communications) that extends and enhances the data flows and knowledge base. The knowledge base and data flows may be extended by: a) receiving a new concept or new time-series data set from the user, b) inferring one or more relations with each new concept and inferring mapping of the new data to existing concepts, and/or c) requesting a user for input through a cognitive dialog that extends data flows and knowledge base where the new concepts or time-series are unable to be mapped to existing knowledge.

It should be noted as described herein, the term “cognitive” (or “cognition”) may be relating to, being, or involving conscious intellectual activity such as, for example, thinking, reasoning, or remembering, that may be performed using a machine learning. In an additional aspect, cognitive or “cognition” may be the mental process of knowing, including aspects such as awareness, perception, reasoning and judgment. A machine learning system may use artificial reasoning to interpret data from one or more data sources (e.g., sensor based devices or other computing systems) and learn topics, concepts, and/or processes that may be determined and/or derived by machine learning.

In an additional aspect, cognitive or “cognition” may refer to a mental action or process of acquiring knowledge and understanding through thought, experience, and one or more senses using machine learning (which may include using sensor based devices or other computing systems that include audio or video devices). Cognitive may also refer to identifying patterns of behavior, leading to a “learning” of one or more events, operations, or processes. Thus, the cognitive model may, over time, develop semantic labels to apply to observed behavior and use a knowledge domain or ontology to store the learned observed behavior. In one embodiment, the system provides for progressive levels of complexity in what may be learned from the one or more events, operations, or processes.

In an additional aspect, the term cognitive may refer to a cognitive system. The cognitive system may be a specialized computer system, or set of computer systems, configured with hardware and/or software logic (in combination with hardware logic upon which the software executes) to emulate human cognitive functions. These cognitive systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. A cognitive system may perform one or more computer-implemented cognitive operations that approximate a human thought process while enabling a user or a computing system to interact in a more natural manner. A cognitive system may comprise artificial intelligence logic, such as natural language processing (NLP) based logic, for example, and machine learning logic, which may be provided as specialized hardware, software executed on hardware, or any combination of specialized hardware and software executed on hardware. The logic of the cognitive system may implement the cognitive operation(s), examples of which include, but are not limited to, question answering, identification of related concepts within different portions of content in a corpus, and intelligent search algorithms, such as Internet web page searches.

In general, such cognitive systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and cognition; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human cognition based on experiences.

Additional aspects of the present invention and attendant benefits will be further described, following.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security parameters, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

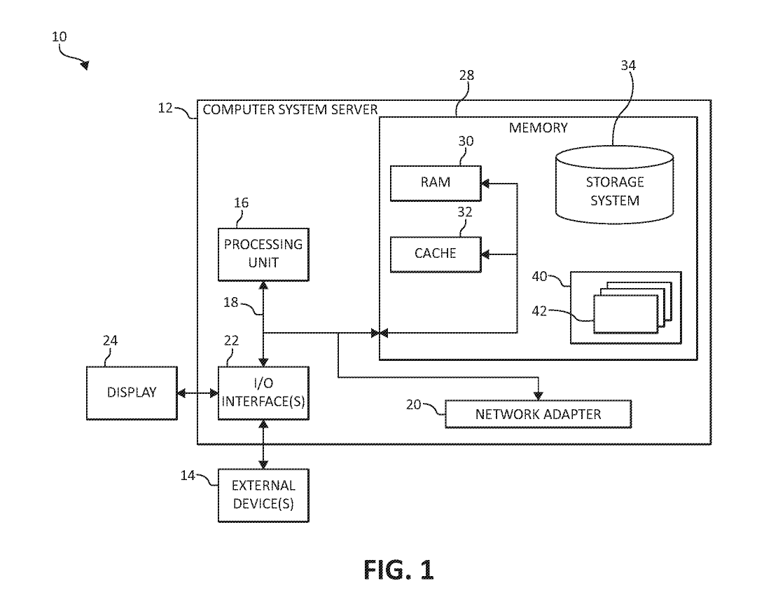

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

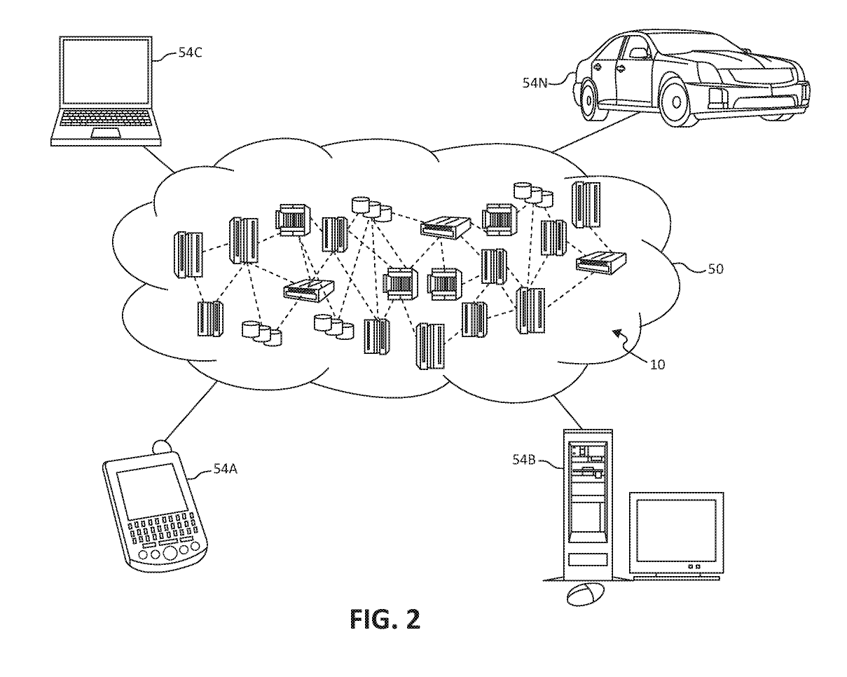

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

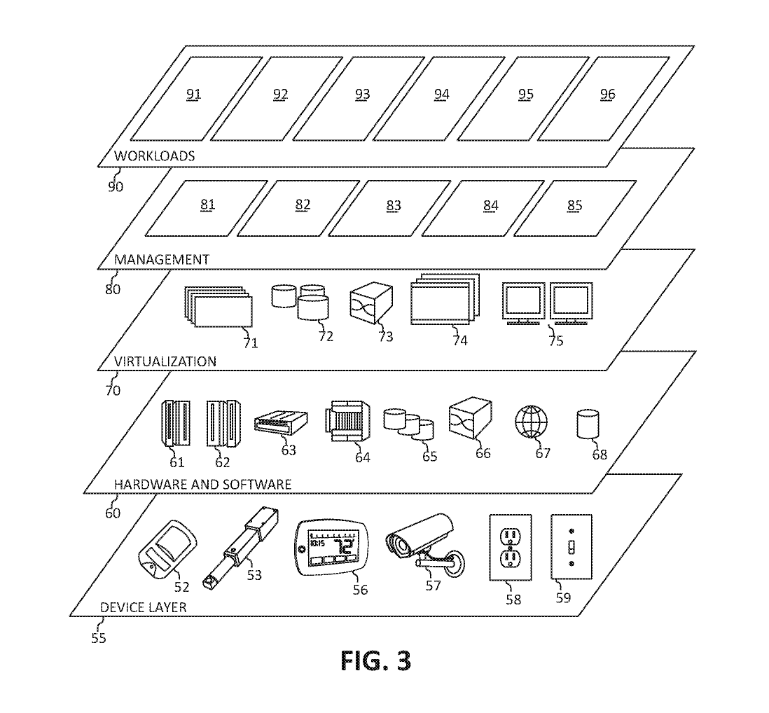

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various cognitive data curation workloads and functions 96. In addition, the cognitive data curation workloads and functions 96 for may include such operations as data analytics, data analysis, and as will be further described, notification functionality. One of ordinary skill in the art will appreciate that the cognitive data curation workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

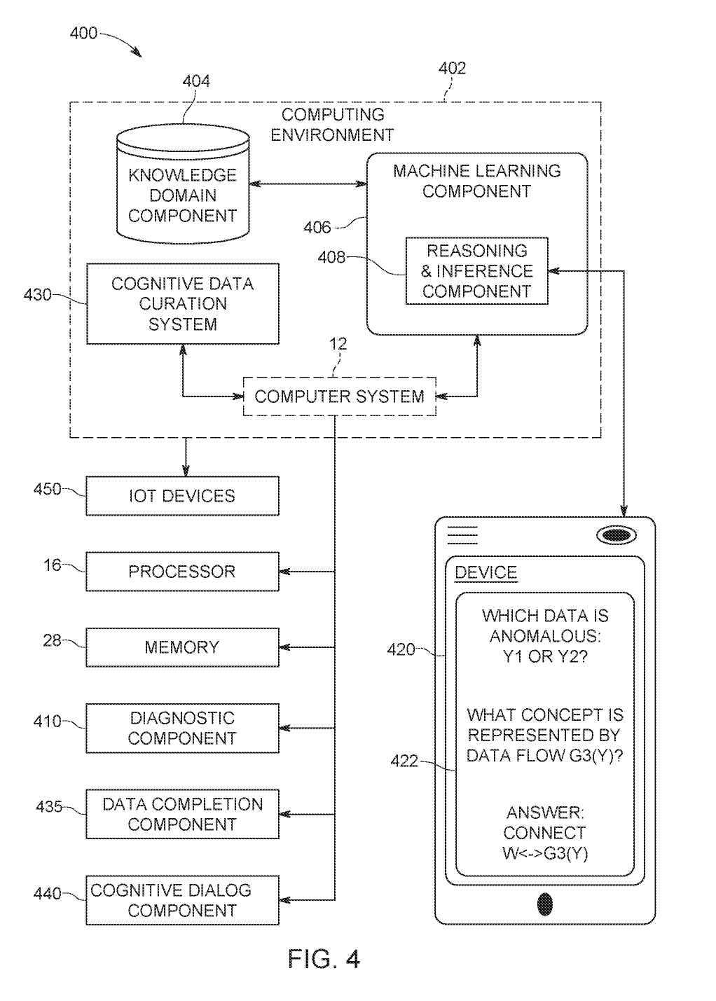

As previously mentioned, the mechanisms of the illustrated embodiments provide novel approaches for cognitive data curation in an IoT computing environment. Turning now to FIG. 4, a block diagram depicting exemplary functional components 400 according to various mechanisms of the illustrated embodiments is shown. FIG. 4 illustrates cognitive data curation workloads and functions and training of a machine learning model in a computing environment, such as a computing environment 402, according to an example of the present technology. As will be seen, many of the functional blocks may also be considered “modules” or “components” of functionality, in the same descriptive sense as has been previously described in FIGS. 1-3. With the foregoing in mind, the module/component blocks 400 may also be incorporated into various hardware and software components of a system for cognitive data curation in accordance with the present invention. Many of the functional blocks 400 may execute as background processes on various components, either in distributed computing components, or on the user device, or elsewhere. Computer system/server 12 is again shown, incorporating processing unit 16 and memory 28 to perform various computational, data processing and other functionality in accordance with various aspects of the present invention.

The system 400 may include the computing environment 402, a cognitive data curation system 430, one or more IoT devices 450 (e.g., IoT sensor devices), and one or more devices such as, for example, device 420 (e.g., a desktop computer, laptop computer, tablet, smartphone, and/or another electronic device that may have one or more processors and memory). The device 420, the IoT devices 450, the cognitive data curation system 430, and the computing environment 402 may each be associated with and/or in communication with each other, by one or more communication methods, such as a computing network. In one example, the device 420, the IoT devices 450, and/or the cognitive data curation system 430 may be controlled by an owner, customer, or technician/administrator associated with the computing environment 402. In another example, the device 420, the IoT devices 450, and/or the cognitive data curation system 430 may be completely independent from the owner, customer, or user of the computing environment 402.

In one aspect, the computing environment 402 may provide virtualized computing services (i.e., virtualized computing, virtualized storage, virtualized networking, etc.) to device 420 and/or the IoT devices 450. More specifically, the computing environment 402 may provide virtualized computing, virtualized storage, virtualized networking and other virtualized services that are executing on a hardware substrate.

As depicted in FIG. 4, the computing environment 402 may include a machine learning component 406, a knowledge domain component 404 that is associated with a machine learning component 406, and the cognitive data curation system 430. The knowledge domain component 404 may also include an ontology, knowledge base, data mappings, and/or other data for the cognitive data curation system 430 and/or associated with IoT devices 450.

The knowledge domain component 404 may be a combination of concepts, relationships between the concepts, machine learning data, features, parameters, data, profile data, historical data, tested and validated data, or other specified/defined data for testing, monitoring, validating, detecting, learning, analyzing, monitoring, and/or maintaining data, concepts, and/or relationships between the concepts in the cognitive data curation system 430. More specifically, the knowledge domain component 404 may include one or more data models representing data, data flows, semantic concepts, and mappings to each of the data flows.

The computing environment 402 may also include a computer system 12, as depicted in FIG. 1. The computer system 12 may also include a diagnostic component 410, data completion component 435, and/or a cognitive dialog component 440 each associated with the machine learning component 406 for training and learning one or more machine learning models and also for applying inferences and/or reasoning pertaining to one or more concepts and relationships between the concepts, or a combination thereof to the machine learning model for cognitive data curation in a cognitive data curation system 430.

In one aspect, the machine learning component 406 may include a reasoning and inference component 408 for cognitively inferring and/or reasoning a relationship and mapping between one or more concepts in the cognitive data curation system 430. The machine learning component 406 may also include and/or use the one or more data models representing data, data flows, semantic concepts, and mappings to each of the data flows. Additionally, the reasoning and inference component 408 may infer a relationship and mapping between a new concept and the one or more concepts. In an additional aspect, the cognitive data curation system may use the machine learning component 406 to run inference on data flows as required for processing one or more user queries and also for detecting and/or resolving data inconsistences.

The diagnostic component 410 may identify inconsistencies and/or anomalies between those of the plurality of data flows used to answer a query for time-series data pertaining to the one or more concepts.

The data completion component 435 may use the one the machine learning component 406 and reasoning and inference component 408 to reason and correct data flows (which may include inconsistencies) and also use to extend and enhance the knowledge domain component 404 (e.g., to extend the knowledge base).

The cognitive dialog component 440 may be used to enable and drive user interaction where input may be required. That is, the cognitive dialog component 440 may request and receive (e.g., from device 420 which may have a graphical user interface 422 “GUI”) new data flows and concepts to resolve the inconsistencies and anomaly flags that are unable to be identified or resolved.

Also, the device 420 may include a graphical user interface (GUI) 422 enabled to display on the device 420 one or more user interface controls for a user to interact with the GUI 422. For example, the GUI 422 may display an interactive dialog with questions and/or answers for retrieving additional input from a user. For example, the GUI 422 may indicate or display audibly and/or visually a question “Which data is anomalous: Y1 or Y2?,” “What concept is represented by dataflow G3(Y)?,” and an answer that states “Answer: connect W with G3(Y).”

The machine learning component 406 may apply one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

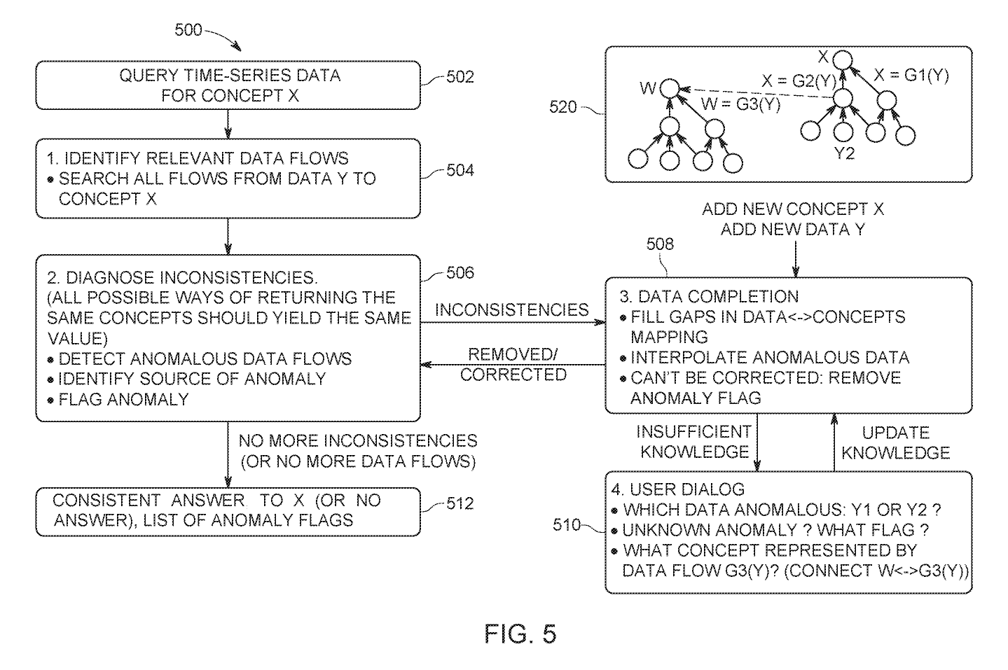

Turning now to FIG. 5, a block diagram of exemplary functionality 500 relating to cognitive data curation in an IoT computing environment is depicted. As shown, the various blocks of functionality are depicted with arrows designating the blocks' 500 relationships with each other and to show process flow. Additionally, descriptive information is also seen relating each of the functional blocks 500. As will be seen, many of the functional blocks may also be considered “modules” of functionality, in the same descriptive sense as has been previously described in FIG. 4. With the foregoing in mind, the module blocks 500 may also be incorporated into various hardware and software components of a system for image enhancement in accordance with the present invention such as, for example, hardware and software components of FIG. 4. Many of the functional blocks 500 may execute as background processes on various components, either in distributed computing components, or on the user device, or elsewhere.

Starting with block 502, a query may be received for time-series data concept “X”. In block 504, one or more relevant data flows may be identified. All data flows may be searched from data “Y” to the concept X. Any inconsistencies may be diagnosed (e.g., determined or detected), as in block 506. That is, anomalous data flows may be detected, a source of the anomaly may be identified, and the anomaly may be flagged. Moving to block 508, a data completion operation may be performed on any inconsistencies. Gaps in the data may be filled with concepts and data mappings. The anomalous data may be interpolated. For those inconsistencies that are unable to be corrected, the anomaly flag may be removed.

In conjunction with and/or parallel to the operations of data completions, a user dialog may be performed for receiving additional input/information (e.g., where there is insufficient knowledge to infer or correct the data), as in block 510. That is, a series of questions and responses may be provided or received from a user. For example, similar to the example of FIG. 4, the user dialog may include a question “Which data is anomalous: Y1 or Y2?,” “Unknown anomaly? What flag?,” “What concept is represented by dataflow G3(Y)?,” and an answer that states “Answer: connect W with G3(Y).” Any updated knowledge may be provided to further complete the data completion operations. From block 508, the removed and/or corrected data may be provided to block 506. As in block 512, a consistent answer (e.g., resolved and corrected data flows used to provide an answer) may be provided to answer concept X. In one aspect, block 512 may also provide no answer and/or provide a list of anomaly flags.

Consider the following additional aspects. For example, consider data processing systems for electrical utilities comprising a semantic model defined by concepts “Sensor”, “Service Point”, “Substation”, “Distr. Utility”, “State”, “energy demand”, “solar generation” and relationships “connected to”, “part of”, and/or “has a.” The data flows may include: metering data at sensors, analytic processes producing features from sensor data, and analytic processes producing estimates of other quantities from sensor data and features, such as, for example, forecasting models. There may also be an instance of semantic concepts and mapping to data flows.

Assume a user requests in a query a “total distributed renewable generation at distribution utility on August 10, 12.00.” The mechanisms of the illustrated embodiments may retrieve multiple data flows answering the query (e.g., search in a GraphDB) such as, for example: a) a sum of all service point metering wind generation, connected to substations, parts of utility; b) a combination of all supervisory control and data acquisitions (“SCADA”) meters connected to substations, parts of utility (electrical load of utility) minus output of electrical demand machine learning model; and/or c) output of wind generation machine learning model, using weather (wind) data features. The present invention may estimate that b) and c) are statistically the same, while a) is inconsistent, with flag “missing renewable contribution”. Accordingly, an inference may be run (e.g., on a model of the joint density of the data), an anomaly signature may be produced from inference results (e.g. using residuals), and/or a set of anomaly signatures may be classified into a known anomaly flag. In one aspect, an inference model may be a latent-variable model of the data Y=f(x)+e, where model inversion and fault diagnosis techniques for residual analysis may detect and/or resolve data inconsistencies.

As a result, a unique estimate may be returned and/or provided as a result of the inference model after removing data flow and a data flow may be flagged (e.g., missing wind contribution).

As an additional example, consider the same query in which a data flow has been flagged as “inconsistent”, in particular “missing wind generation”. In one aspect, the present invention may contain unlabeled data that may be appropriate to properly answer the query. The present invention may detect any unlabeled data that could map to an entity of interest through an unsupervised learning algorithm (e.g., K-nearest neighbor). Once the data for that entity has been properly labelled, the properly labelled data may be used to try to correct any gap in a data flow.

In addition, in the event that there is no unlabeled data available to fill and/or correct a gap in the data flows, the present invention may estimate the data for which a gap exists (interpolation, extrapolation/prediction) given contextual information (e.g., type of time-series/data) and part of the data available. The present invention may know what the gap is in the data flow. However, one or more of the previous options are able to be used to fix the inconsistencies. The user may upload missing information (e.g., data for new wind generator). The present invention may either change the flag to resolved and/or leave it unresolved, possibly including an explanation of why it could not be resolved.

In an additional embodiment, consider a data processing system for electrical utilities with a semantic model defined by concepts such as, for example: “sensor”, “service point”, “substation”, “distribution utility”, “state”, “energy demand”, “solar generation” and relationships between these concepts such as “connected to”, “part of”, “has a”, and the like. Each concept may be defined by a set of attributes. A user may add a new concept into the data model defined by a set of attributes, which may be “energy supply” and the value “solar energy”. The mechanisms of the illustrated embodiments enable extensions through automatic relations discovery. A rule-based classification operation may be used to extract rules that explain the existence of relations for an entity given some of the attributes of the entity (if any exists). Given the semantic model, a rule-based operation may determine and/or learn a rule according to, for example, which if/then relationship holds such as, for example, if [“energy supply”=“solar energy”] then the relation is a “renewable energy source”. Based on one or more rules that may be learned from the experience, the present invention may add to that concept a relation such as, for example, “renewable energy source”. It should be noted, the one or more queries such as, for example, a “total renewable generation at distribution utility” may be able to derive data flows mapped to solar energy in the response to the query, which were unknown to the system before.

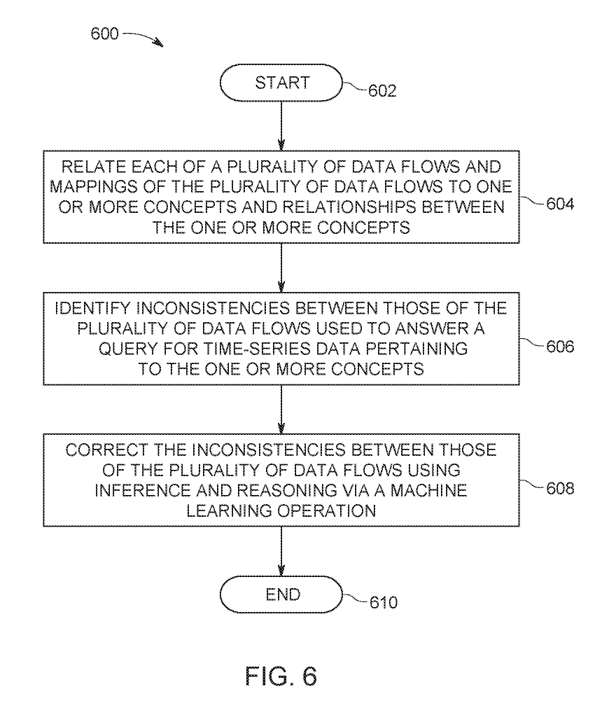

Turning now to FIG. 6, a method 600 for cognitive data curation in an Internet of Things (IoT) computing environment is depicted, in which various aspects of the illustrated embodiments may be implemented. The functionality 600 may be implemented as a method executed as instructions on a machine, where the instructions are included on at least one computer readable medium or on a non-transitory machine-readable storage medium. The functionality 600 may start in block 602. Each data flow and mapping of the data flows may be related to one or more concepts and relationships between the one or more concepts, as in block 604. One or more inconsistencies may be identified between those data flows used to answer a query for time-series data pertaining to the one or more concepts, as in block 606. The inconsistencies between those of the plurality of data flows may be corrected using inference and reasoning via a machine learning operation, as in block 608. The functionality 600 may end in block 610.

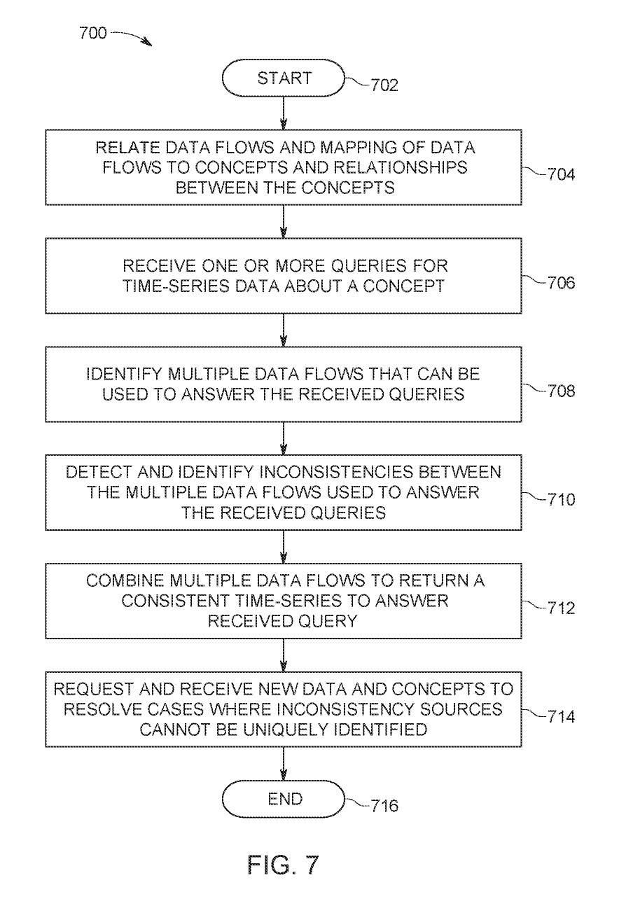

Turning now to FIG. 7, an additional method 700 is illustrated for cognitive data curation in a computing environment, in which various aspects of the illustrated embodiments may be implemented. The functionality 700 may be implemented as a method executed as instructions on a machine, where the instructions are included on at least one computer readable medium or on a non-transitory machine-readable storage medium. The functionality 700 may start in block 702. Data flows and mapping of data flows may be related to concepts and relationships between the concepts, as in block 704. One or more queries may be received for time-series data about a concept, as in block 706. Multiple data flows may be identified that can be used to answer the received queries, as in bloc 708. Inconsistencies between the multiple data flows used to answer the received queries may be detected and/or identified, as in block 710. The multiple data flows may be combined to return a consistent time-series to answer received query, as in block 712. New data and concepts may be requested (e.g., from a user) and received (e.g., from the user) to resolve cases (e.g., detected inconsistencies in data flows) where inconsistency sources cannot be uniquely identified, as in block 714. The functionality 700 may end in block 716.

In one aspect, in conjunction with and/or as part of at least one block of FIGS. 6-7, the operations of 600 and/or 700 may include each of the following. The operations of 600 and/or 700 may flag those of the plurality of data flows having the inconsistencies with an anomaly flag.

The operations of 600 and/or 700 may request and receive new data flows and concepts to resolve the inconsistencies and anomaly flags that are unable to be identified or resolved. Additionally, the operations of 600 and/or 700 may receive one or more new concepts and time-series data in new data flows, and/or develop new relationships between one or more new concepts and the time-series data based on existing relationships using the machine learning operation. The operations of 600 and/or 700 may further infer a relationship and mapping between a new concept and the one or more concepts.

In an additional aspect, the operations of 600 and/or 700 may engage in an interactive communication dialog with a user to identify the new relationships and to augment an existing knowledge domain. Moreover, in association with correcting the inconsistencies, the operations of 600 and/or 700 may create one or more new data flows based on an interpolation or extrapolation of related data flows, and/or create a mapping between the one or more concepts and unlabeled sets of data using the machine learning operation.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

What is claimed is:

1. A method, by a processor, for cognitive data curation in an Internet of Things (IoT) computing environment, comprising:
relating each of a plurality of data flows and mappings of the plurality of data flows to one or more concepts and relationships between the one or more concepts of a semantic knowledge base;
identifying inconsistencies between those of the plurality of data flows used to answer a query for time-series data pertaining to the one or more concepts; and
correcting the inconsistencies between those of the plurality of data flows using inference via a machine learning operation and reasoning on the semantic knowledge base.

2. The method of claim 1, further including flagging those of the plurality of data flows having the inconsistencies with an anomaly flag.

3. The method of claim 1, further including requesting and receiving new data flows and concepts to resolve the inconsistencies and anomaly flags that are unable to be identified or resolved.

4. The method of claim 1, further including:
receiving one or more new concepts and time-series data in new data flows; and
developing new relationships between one or more new concepts and the time-series data based on existing relationships using the machine learning operation and reasoning on the semantic knowledge base.

5. The method of claim 1, further including inferring a relationship and mapping between a new concept and the one or more concepts.

6. The method of claim 1, further including engaging in an interactive communication dialog with a user to identify the new relationships and to augment an existing knowledge domain.

7. The method of claim 1, wherein correcting the inconsistencies further includes:
creating one or more new data flows based on an interpolation or extrapolation of related data flows; and
creating a mapping between the one or more concepts and unlabeled sets of data using the machine learning operation and reasoning on the semantic knowledge base.

8. A system, for cognitive data curation in an Internet of Things (IoT) computing environment, comprising:
one or more processors with executable instructions that when executed cause the system to:
relate each of a plurality of data flows and mappings of the plurality of data flows to one or more concepts and relationships between the one or more concepts of a semantic knowledge base;
identify inconsistencies between those of the plurality of data flows used to answer a query for time-series data pertaining to the one or more concepts; and
correct the inconsistencies between those of the plurality of data flows using inference via a machine learning operation and reasoning on the semantic knowledge base.

9. The system of claim 8, wherein the executable instructions further flag those of the plurality of data flows having the inconsistencies with an anomaly flag.

10. The system of claim 8, wherein the executable instructions further request and receive new data flows and concepts to resolve the inconsistencies and anomaly flags that are unable to be identified or resolved.

11. The system of claim 8, wherein the executable instructions further:
receive one or more new concepts and time-series data in new data flows; and
develop new relationships between one or more new concepts and the time-series data based on existing relationships using the machine learning operation and reasoning on the semantic knowledge base.

12. The system of claim 8, wherein the executable instructions further infer a relationship and mapping between a new concept and the one or more concepts.

13. The system of claim 8, wherein the executable instructions further engage in an interactive communication dialog with a user to identify the new relationships and to augment an existing knowledge domain.

14. The system of claim 8, wherein correcting the inconsistencies further includes:
creating one or more new data flows based on an interpolation or extrapolation of related data flows; and
creating a mapping between the one or more concepts and unlabeled sets of data using the machine learning operation and reasoning on the semantic knowledge base.

15. A computer program product for, by one or more processors, cognitive data curation in an Internet of Things (IoT) computing environment, the computer program product comprising a non-transitory computer-readable storage medium having computer-readable program code portions stored therein, the computer-readable program code portions comprising:
an executable portion that relates each of a plurality of data flows and mappings of the plurality of data flows to one or more concepts and relationships between the one or more concepts of a semantic knowledge base;
an executable portion that identifies inconsistencies between those of the plurality of data flows used to answer a query for time-series data pertaining to the one or more concepts; and
an executable portion that corrects the inconsistencies between those of the plurality of data flows using inference via a machine learning operation and reasoning on the semantic knowledge base.

16. The computer program product of claim 15, further including an executable portion that flags those of the plurality of data flows having the inconsistencies with an anomaly flag.

17. The computer program product of claim 15, further including an executable portion that requests and receives new data flows and concepts to resolve the inconsistencies and anomaly flags that are unable to be identified or resolved.

18. The computer program product of claim 15, further including an executable portion that:
receives one or more new concepts and time-series data in new data flows;
develops new relationships between one or more new concepts and the time-series data based on existing relationships using the machine learning operation and reasoning on the semantic knowledge base; and
engages in an interactive communication dialog with a user to identify the new relationships and to augment an existing knowledge domain.

19. The computer program product of claim 15, further including an executable portion that infers a relationship and mapping between a new concept and the one or more concepts.

20. The computer program product of claim 15, wherein correcting the inconsistencies further includes an executable portion that:
creates one or more new data flows based on an interpolation or extrapolation of related data flows; and
creates a mapping between the one or more concepts and unlabeled sets of data using the machine learning operation and reasoning on the semantic knowledge base.
